(19) United States
(12) Patent Application Publication
(10) Pub. No.: US 2006/0204736 A1
(43) Pub. Date: Sep. 14, 2006

(54) Adhesive tape produced using a hot-melt technique and having an opaque BOPP backing film

(75) Inventor: Luca De Carolis, San Salvo (Chieti) (IT)

Correspondence Address: SUGHRUE MION, PLLC, 2100 PENNSYLVANIA AVENUE, N.W., SUITE 800, WASHINGTON, DC, 20037, US

(73) Assignee: VIBAC S.p.A.

(21) Appl. No.: 11/357,170

(22) Filed: Feb. 21, 2006

(30) Foreign Application Priority Data
Feb. 18, 2005 (EP) 05425086.5

(51) Int. Cl. B32B 7/02; B32B 15/04; B32B 7/12; B32B 27/34; B05D 3/12

(52) U.S. Cl. 428/212; 428/476.9; 428/516; 428/347; 428/354; 427/356; 427/372.2; 427/223

(57) ABSTRACT

The adhesive tape has an adhesive layer of the hot-melt type applied to a backing film based on biorientated polypropylene. This film comprises in succession at least a first layer comprising polypropylene or a mixture of polypropylene resins having a melting point of between 150 and 170° C. and an MFI of between 1 and 5 g/10 min at a temperature of 230° C. and 2.16 kg, an opaque layer comprising a polyethylene-based resin having a melting point of between 120 and 150° C. and an MFI of between 1 and 5 g/10 min at a temperature of 230° C. and 2.16 kg, and a layer of polyamide-resin-based lacquer.

This invention relates to a backing film for adhesive tape, the corresponding process of manufacture and an adhesive tape comprising such backing, produced using a technique of the hot-melt type.

The manufacture of adhesive tapes using a technique of the hot-melt type has become increasingly common recently in comparison with techniques of the “solvent” or “acrylic” type, in which the adhesive is applied to the backing film dissolved in an organic solvent, such as for example hexane or water, respectively.

In order to produce an adhesive tape using a technique of the hot-melt type, an adhesive mass which has been mixed and heated in suitable extruders is applied to a backing film at a temperature which typically lies between 160 and 200° C. This technique is eco-compatible in that it does not require the use of organic solvents and also guarantees higher productivity than techniques of the “solvent” or “acrylic” type as it does not provide for a stage of drying the adhesive mass, which is applied in the molten state. Moreover, the relatively high temperatures required by the hot-melt technique make it necessary to use an adequately heat-resistant backing film, for example one based on biorientated polypropylene (BOPP), ruling out use of the material which has hitherto been most commonly used for the purpose, that is polyvinyl chloride (PVC).

However, a backing film based on BOPP is of a clear colour because of its intrinsic gloss. Furthermore, its outer surface must be subjected to particular chemical and/or physical treatments so that it can be printed using the normal inks used in flexographic printing. On the other hand, a PVC-based backing film is opaque and is intrinsically printable without the need for any ad hoc surface treatments.

The purpose of this invention is therefore to provide a BOPP-based backing film for adhesive tape of the hot-melt type which also has the advantageous properties just mentioned of a PVC-based backing film.

This object is accomplished through a backing film based on biorientated polypropylene comprising in succession at least a first layer comprising polypropylene or a mixture of polypropylene resins having a melting point of between 150 and 170° C. and an MFI (melt flow index) of between 1 and 5 g/10 min at a temperature of 230° C. and 2.16 kg, an opaque layer comprising a polyethylene-based resin having a melting point of between 120 and 150° C. and an MFI (melt flow index) of between 1 and 5 g/10 min at a temperature of 230° C. and 2.16 kg, and a layer of polyamide-resin-based lacquer.

Advantageously the film according to the invention comprises a second layer placed between the first layer and the opaque layer and comprising polypropylene or a mixture of polypropylene resins having a melting point of between 150 and 170° C. and an MFI (melt flow index) of between 1 and 5 g/10 min at a temperature of 230° C. and 2.16 kg.

Preferably the polyamide resin in the lacquer layer has a T_{g} of between 95 and 140° C. and an acid number of between 2 and 6 to permit good flexographic printing using the normal inks used for that purpose.

A further subject of this invention is a process for the production of a backing film for adhesive tape of the type indicated above comprising the stages of:

coextruding the aforesaid first layer, second layer, if present, and opaque layer,

treating the outer surface of the opaque layer so that its surface tension has a value of at least 38 N/m,

applying a mixture of polyamide resin dissolved in a solvent to the said outer surface of the opaque layer, and

heating the said mixture to cause evaporation of the solvent and the formation of a lacquer layer.

Advantageously the outer surface of the opaque layer is flame treated so that its surface tension has a value of at least 38 N/m. Again advantageously, the concentration by weight of the polyamide resin in the solvent is between 7 and 15% and such solvent is selected from toluene, isopropyl alcohol and their mixtures.

Yet a further subject of this invention is an adhesive tape comprising a backing film of the type indicated above, together with an adhesive layer of the hot-melt type adhering to the first layer of backing film.

This adhesive layer is typically based on synthetic rubbers, because the latter have the necessary thermoplastic properties to permit application of the hot-melt technique, which takes place in a manner which is in itself conventional.

Further advantages and features of this invention will be apparent from the following examples of film compositions provided by way of a non-restrictive example in which the values in μm represent the thicknesses of the various layers.

### EXAMPLE 1

| Adhesive layer: | adhesivity = 550 g/cm | |
|---|---|---|
| First layer: | polypropylene homopolymer MFI 2 | 1.5 μm |
| Second layer: | polypropylene homopolymer MFI 3 | 27 μm |
| Opaque layer: | polyethylene homopolymer MFI 3 | 1.5 μm |
| Lacquer layer: | polyamide lacquer with T_{g} of 115° C. and | 3.5 g/m² |
| | an acid No. of 5 in 7% toluene/isopropyl | |
| | alcohol solution | |

The adhesivity of the adhesive layer was measured using the following method.

A PSTC (Pressure Sensitive Technical Council) steel plate 137.1 mm (5.4 inches) long and 50.8 mm (2 inches) wide was prepared and the rolls of tape under test were conditioned at 23° C.±2° C. and a relative humidity of 50%±5% for 24 hours.

Before each measurement the plate was cleaned with technical hexane and then with acetone using sterile gauzes.

A strip of the adhesive tape under test, which was 1 cm wide and at least 20 cm long, was caused to adhere to the plate, avoiding any air inclusions. Perfect adhesion was guaranteed by 10 successive passes using an automatic rubber-covered roller having a weight of 2 kg at a speed of 300 mm/minute.

The plate was then secured in one of the two clamps of a dynamometer, while an end of the tape was attached to the other clamp. The clamps were then moved apart at a rate of 300 mm/minute with a tape removal angle of 180°.

The mean force applied (measured in g/cm) for detachment of the sample of adhesive from the steel plate is the adhesiveness value of the sample under test.

The test was repeated 3 times using different test specimens for each roll under test. The final result of the test is given by the arithmetic mean of the three values found.

### EXAMPLE 2

| | | |
|---|---|---|
| Adhesive layer: | adhesivity = 600 g/cm (measured using | |
| | the method described above) | |
| First layer: | polypropylene homopolymer MFI 2 | 1.5 μm |
| Second layer: | polypropylene homopolymer MFI 3 | 27 μm |
| Opaque layer: | polyethylene homopolymer MFI 3 | 1.5 μm |
| Lacquer layer: | polyamide lacquer with T_{g} of 115° C. and | 3.5 g/m² |
| | an acid No. of 5 in 15% toluene/isopropyl | |
| | alcohol solution | |

Of course, details of manufacture and embodiments may be varied extensively with respect to what has been described above, purely by way of example, without affecting the principle of the invention and without thereby going beyond its scope.

1. Backing film based on biorientated polypropylene for adhesive tape of the hot-melt type, comprising in succession at least a first layer comprising polypropylene or a mixture of polypropylene resins having a melting point of between 150 and 170° C. and an MFI (melt flow index) of between 1 and 5 g/10 min at a temperature of 230° C. and 2.16 kg, an opaque layer comprising a polyethylene-based resin having a melting point of between 120 and 150° C. and an MFI (melt flow index) of between 1 and 5 g/10 min at a temperature of 230° C. and 2.16 kg, and a layer of polyamide-resin-based lacquer.

2. Film according to claim 1, comprising a second layer placed between the first layer and the opaque layer and comprising polypropylene or a mixture of polypropylene resins having a melting point of between 150 and 170° C. and an MFI (melt flow index) of between 1 and 5 g/10 min at a temperature of 230° C. and 2.16 kg.

3. Film according to claim 1, in which the polyamide resin has a T_{g} of between 95 and 140° C. and an acid number of between 2 and 6.

4. Process for the production of a backing film for hot-melt adhesive tape, comprising in succession at least a first layer comprising polypropylene or a mixture of polypropylene resins having a melting point of between 150 and 170° C. and an MFI (melt flow index) of between 1 and 5 g/10 min at a temperature of 230° C. and 2.16 kg, an opaque layer comprising a polyethylene-based resin having a melting point of between 120 and 150° C. and an MFI (melt flow index) of between 1 and 5 g/10 min at a temperature of 230° C. and 2.16 kg, and a layer of polyamide-resin-based lacquer,
said process comprising the stages of:
coextruding the aforesaid first layer, a second layer, if present, and the opaque layer,
treating the outer surface of the opaque layer so that its surface tension has a value of at least 38 N/m,
applying a mixture of polyamide resin dissolved in a solvent to the said outer surface of the opaque layer, and
heating the said mixture to cause evaporation of the solvent and the formation of a lacquer layer.

5. Process according to claim 4, in which the outer surface of the opaque layer is flame treated so that its surface tension has a value of at least 38 N/m.

6. Process according to claim 4, in which the concentration by weight of the said polyamide resin in the solvent is between 7 and 15%.

7. Process according to claim 4, in which the said solvent is selected from toluene, isopropyl alcohol and their mixtures.

8. Hot-melt adhesive tape including a backing film comprising in succession at least a first layer comprising polypropylene or a mixture of polypropylene resins having a melting point of between 150 and 170° C. and an MFI (melt flow index) of between 1 and 5 g/10 min at a temperature of 230° C. and 2.16 kg, an opaque layer comprising a polyethylene-based resin having a melting point of between 120 and 150° C. and an MFI (melt flow index) of between 1 and 5 g/10 min at a temperature of 230° C. and 2.16 kg, and a layer of polyamide-resin-based lacquer together with an adhesive layer of the hot-melt type adhering to the first layer of the backing film.
